(19) United States
(12) Patent Application Publication
(10) Pub. No.: US 2002/0023081 A1
(43) Pub. Date: Feb. 21, 2002

(54) System and method for providing medical information via the internet without the need for broadband connectivity

(76) Inventors: Silvia L. Bazan, Atlanta, GA (US); John C. Trigg, Atlanta, GA (US)

Correspondence Address: Carter, Ledyard & Milburn, Suite 300, 1401 Eye Street, N.W., Washington, DC, 20005, US

(21) Appl. No.: 09/928,398

(22) Filed: Aug. 14, 2001

Related U.S. Application Data
(60) Provisional application No. 60/225,259, filed on Aug. 15, 2000.

(51) Int. Cl. G06F 7/00

(52) U.S. Cl. 707/1; 707/104.1

(57) ABSTRACT

The invention relates to a method and process for providing a high quality multimedia presentation using a standard Internet dial up connection without any specialized broad band connectivity. The process and method uses a combination of compression and coding techniques that permit a user to view the initial segments of a multimedia presentation while simultaneously downloading subsequent segments of the multimedia presentation. The placement of specific commands within the multi media presentation provides a seamless and high quality multimedia presentation. The method may be used to provide high quality and seamless multimedia presentations of medical case histories and other medical topics without the need for specialized broadband connectivity.

### RELATED APPLICATIONS

The subject matter of this application has previously been described in Provisional Application No. 60/225,259 filed on Aug. 15, 2000 and the applicants claim the priority thereof.

### BACKGROUND OF THE INVENTION

This invention relates to a method and Internet based application for the seamless presentation of high quality multimedia programming incorporating audio, video and graphic material using standard Internet dial-up connections without the need for special broadband connectivity. The method permits the linking of compressed media files to allow for quiet downloading without sacrificing quality. More specifically, the present invention provides a method for the seamless multimedia presentation of medical information to both professionals and consumers, by the presentation of medical case histories.

The Internet is a decentralized global network of computers that communicate using standard electronic communication protocols and languages. The Internet provides a cost-effective and increasingly accessible system of electronic communication. The Internet permits the on-demand distribution of digital text, sound and video images to small selected groups or a global audience. The Internet also permits the use of such interactive elements as voice command, text entry, touch screen and video capture.

The transmission and receipt of digital information on the Internet generally requires a large number of discrete electronic events. In a typical situation, an application program on a user's personal computer allows the user to access information that may be stored on a server located at a geographically remote location. This so-called browser program uses standard protocols and language to make requests of remote web servers on behalf of the user. As illustrated in FIG. 1, the browser of a user (e.g. resident or intern at a hospital) generates an initial request for information. This initial request may be electronically transmitted from the user's client computer 10 to the user's Internet Service Provider (“ISP”) 14 by a modem 12 that is connected to a conventional telephone line 13. The modem 12 converts the digital signal of the computer to the analog signal that is used in conventional phone lines. The user's ISP 14 then transmits the request by the communications backbone of the Internet 16, to the addressee's web server's ISP 18. The request is then forwarded to the addressee server 20. The addressee server 20 may then respond to the request by reversing the above described process.

Web based material is typically organized as individual web pages. Each time a user attempts to load a new web page into his or her browser, another series of requests to retrieve the content of the particular web page may be sent from the client computer to the appropriate remote web server or servers. Once the targeted web server has received a request and transmitted the information to the client server, the user's browser assembles the information for viewing on the user's computer screen.

In the case of a web page that contains multiple media files, each request for a specific image, text or audio file may need to be sent repeatedly to a selected server. This means that if a particular web page contains twenty (20) distinct media elements no less than twenty separate information requests may be directed to a remote server or servers. Furthermore, if a user continues to another page of a web site or to another web site, the browser may again have to retrieve the information from the appropriate server.

The speeds of Internet transmission or bandwidth is generally proportional to the amount of data transmitted or received per unit of time. A basic dial-up modem may provide a connection speed of about 56 kilobytes per second (“kbps”) while other commonly used modems may provide a connection speed of about 128 kbps. In contrast, so called DSL connections may provide connection speeds of between about 128 kbps to about 1.4 megabytes, while T-1 connections may provide even faster connection speeds. In practice, the actual speed of transmission may also be limited by various factors including the number of messages that are necessary to transmit, receive and present a web page and the physical capabilities of the equipment and network. Although the availability of various broadband capabilities is rapidly increasing, for many users the 56 kbps dial-up modem continues to be one of the most economical and widely accessible means of Internet access.

The typical Internet based multimedia presentation uses a combination of text, sound and/or video images. The typical multimedia presentation may also involve multiple display areas, images or concurrent presentations. The text, sound and video elements that are used in an Internet based multimedia presentation may be prepared and stored as digital component files. The digital audio and image files that are used in such multimedia presentations may be extremely large. Because Internet bandwidth is generally proportional to the amount of data transmitted, it generally takes much more bandwidth to download large media files containing photographic and video elements then its does to download a simple page of text.

The relatively slow download speed of a commonly used Internet dial-up connection, such as the widely 56 kbps modem, generally does not permit the effective use of high bandwidth multimedia design elements. For example, using a 56 kbps modem, the time required to download a digital file is approximately one second for every four kilobytes of information. Therefore, using a conventional 56 kbps modem, a web based multimedia presentation containing about 400 kilobytes of information will take approximately 100 seconds to download. This relatively slow download speed can be extremely vexing to users and may seriously comprise the quality of a user's multimedia experience. In practice, such limitations on download speed have severely compromised the utility and quality of Intranet multimedia presentations. This particularly is true for programs and applications that are intended to present highly specialized or technical information.

The present invention utilizes a novel combination of scripted programming commands and compression techniques to minimize the downloading time of large media files. The process for the linking of digital electronic files permits the seamless presentation of high-quality, large-file-size material which may include combinations of audio, video and graphical material. The method provides a seamless high quality multimedia presentation even for persons who use a conventional dial-up modem.

It is an object of the present invention to provide a novel method and system for multimedia presentations using a novel combination of program commands and compression techniques

It is an object of the present invention to provide a novel method and system which facilitates the presentation of complex multimedia subject matter information by significantly reducing the time required for downloading a multimedia presentation without compromising the quality of the presentation.

It is another object of the present invention to provide a novel method and system for the seamless and high quality multimedia presentation of selected medical case histories and related information by the Internet using a conventional dial-up modem and without specialized broadband capability.

It is yet another object of the present invention to provide a novel method and system for providing Internet based multimedia presentations through the compression and linking of different types of media component files.

It is a further object of the present invention to provide a novel method and system for downloading upcoming portions of a large web based multimedia presentation while other portions of the presentation are being contemporaneously viewed by the user.

It is yet a further object of the present invention to provide a novel method and system for viewing an web based multimedia presentation using a dial up modem without discernable breaks or delays in the multimedia presentation.

The present invention provides significant advantages to persons using conventional dial-up modems. However, it will be apparent to one skilled in the art that the method and system may be readily adapted to other forms of types of connectivity. Moreover, although it is particularly well suited to the high quality multimedia presentation of medical case histories and other medical information, the method is broadly applicable to all forms of Internet based multimedia presentations.

These and many other features, objects and advantages of the invention will be readily apparent to one skilled in the art for and to which this invention pertains from the following detailed description of preferred embodiments when read in conjunction with the accompanying figures and drawings.

### BRIEF DESCRIPTION OF DRAWINGS

FIG. 1 schematically illustrates the connection between a user and a remote Internet server.

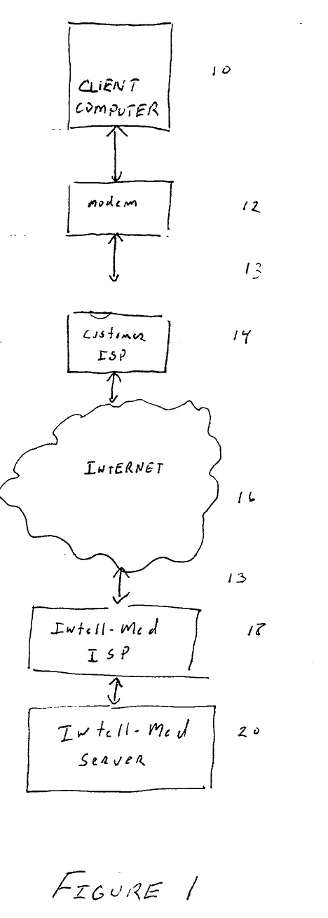

FIG. 2 is a schematic illustration of the method used to prepare a seamless multimedia presentation using a dial up modem.

FIG. 3 is a schematic illustration of the preparation of a multimedia medical case history presentation using the method.

### DESCRIPTION OF PREFERRED EMBODIMENTS

The text, sound and video elements that are used in an Internet based multimedia presentation may be prepared and stored as digital component files. The invention provides a process for linking the component files of a multimedia presentation. The linking of component files when used with available compression techniques allows for faster downloading of large media files without any apparent diminution in program quality being apparent to the user. The process and method allows a user to simultaneously download upcoming portions of a multimedia presentation while a portion of the presentation is being simultaneously viewed by the user.

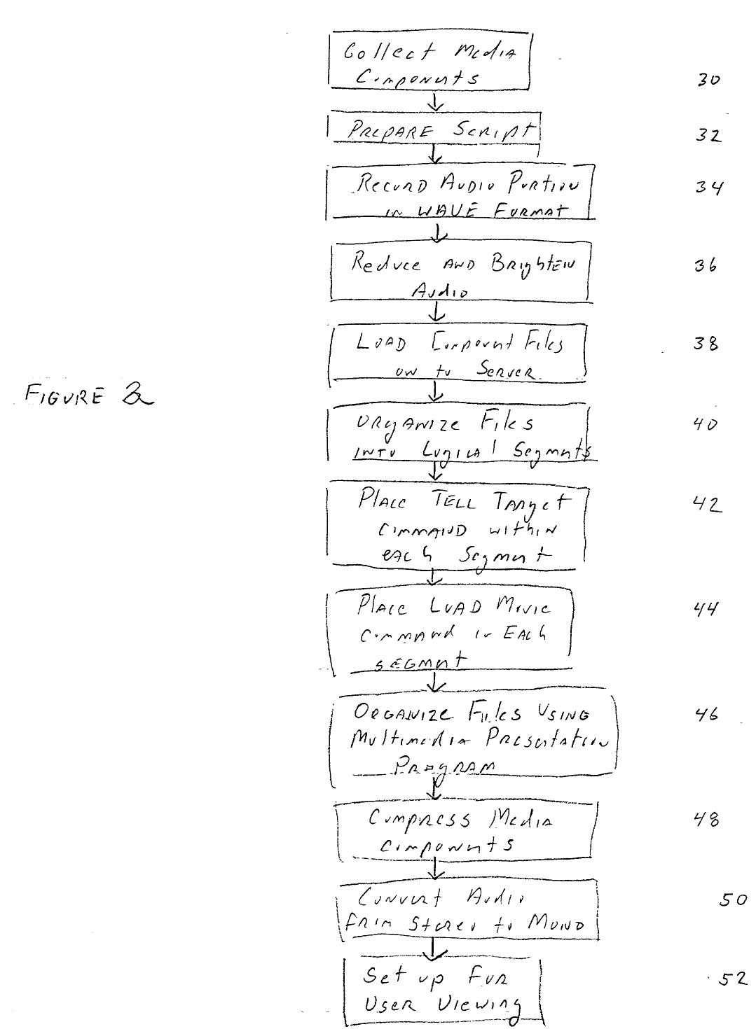

The process uses a novel combination of compression and coding techniques. As schematically illustrated in FIG. 2, the process begins by collecting the media elements of a multimedia presentation 30 and preparing a script 32 of the multimedia presentation. This script 32 typically identifies the key audio components of a presentation together with any associated graphical or visual elements. Once a script 32 is finalized, the audio portion of the presentation may be recorded 34 and then converted to a standard WAVE format. The recorded audio portion may then be reduced to 11 kilohertz using a 16-bit audio format 36. The recorded audio may then be stored in a WAVE format on a CD-ROM or other appropriate means.

The individual digital component media files may then be loaded on a selected server. The individual program elements are then organized based on the script 38. The component media files are then separated into discrete presentation segments 40. In practice, the length of each presentation segment may be varied depending on program content and the desired presentation quality. Ideally, for a 56 kbps modem, the length of each presentation segment should not exceed about 1,000 frames. At a receiving speed of eight frames per second, this is approximately two minutes of an audio presentation. It has also been found desirable to limit the size of the initial presentation segment to less then about 500 frames. This significantly reduces the time required to begin initial viewing of a multimedia presentation when using a conventional dial-up modem.

The transmission and seamless presentation of the multimedia presentation may be further facilitated by the placement of specific computer commands to link the presentation segments during downloading of the program. The specific break points in a presentation segment may be identified by placing a tell-target command in each presentation segment 42. At a specified point in the presentation, the tell-target command 42 signals the user's operating system to begin the process of playing a different segment of the presentation.

A load-movie command may also be inserted in each presentation segment 44. At a predetermined point in the presentation of a selected segment, this load movie command instructs the user's operating system to look forward for the next segment. The load movie command 44 may be used to control the downloading of each presentation segment. For example, in a presentation segment containing 1,000 frames, the load movie command will begin the process of downloading the following presentation segment at frame 470 of the currently playing presentation segment. Thus, while the remaining 530 frames of the current 1,000 frame segment are being viewed by the user, the next succeeding presentation segment is being downloaded from a web server to the user's browser. This facilitates the simultaneous viewing and downloading of the multimedia presentation.

The presentation files are organized and adapted for web based presentation using conventional website development and programming tools. 46. In the present embodiment, the method utilizes various available compression tools and multimedia web site development tools such as Macromedia's FLASH, FIREWORKS and DREAMWEAVER programs to provide a high quality web based presentation. In addition, the visual elements of the presentation may be preferably converted to a JPEG format 48 and compressed by between 60 to 80%. In order to further facilitate compression, presentation graphics are preferably created using a line art illustration program, such as Adobe's ILLUSTRATOR, to reduce the size of the files to be compressed. The audio components are similarly converted to an MP3 format 46 and are also compressed to 80%. The audio may then be converted from stereo to mono at 24 kbps 50. The actual amount of compression may be adjusted to accommodate the desired program quality. In general, the greater the compression, the faster will be the download speed. However, increased compression may reduce presentation quality.

The presentation may then be set up for web based viewing using the HTML protocol 52. The web based presentation may be viewed using a commercially available viewer program such as Macromedia's SHOCKWAVE or Apple's QUICKTIME.

The present invention is extremely well suited to the multimedia presentation of selected medical information, particularly to the presentation of medical case histories. By way of example, the present, invention may be used to provide comprehensive medical information to doctors, medical professionals and consumers. In such an embodiment, a website may be used to distribute medical information to both medical professionals and consumers. In this embodiment, the physician section of a site will provide detailed information regarding specific medical disorders including detailed case histories and supporting information. The consumer section may provide consumers with up-to-date information regarding medical developments and issues, including case histories.

In this particular embodiment, the main web page of the site may contain a menu displaying various categories of information organized by medical specialty. The doctors and consumers will each be able to move through selected sections of the site using conventional navigation means. Thus, users may move though a series of menus and prompts and select a specific case history from a drop-down menu. In this embodiment, each case history presentation shall comprise a specially prepared multimedia presentation consisting of texts, graphics and audio that are adapted to the needs of specific target audiences. The multimedia format, means that a case history narrative may be readily supplemented by additional visual elements as x-rays, diagnostic imaging and photographs.

Once a specific medical case history has been selected, the user will be presented with an initial downloading screen. During an initial period of less than one minute, the first few minutes of the multimedia case presentation may be downloaded to the browser using the method as generally described and illustrated in FIG. 2. Once the initial segment is downloaded, the user may then begin to view the selected medical case history, while the remaining portions of the multimedia case history is downloaded to the user's browser. In this way, the multimedia presentation of the medical case history begins almost immediately and is seamless to the user. The multimedia presentation may be downloaded using a using a conventional dial-up modem and viewed by the user's browser.

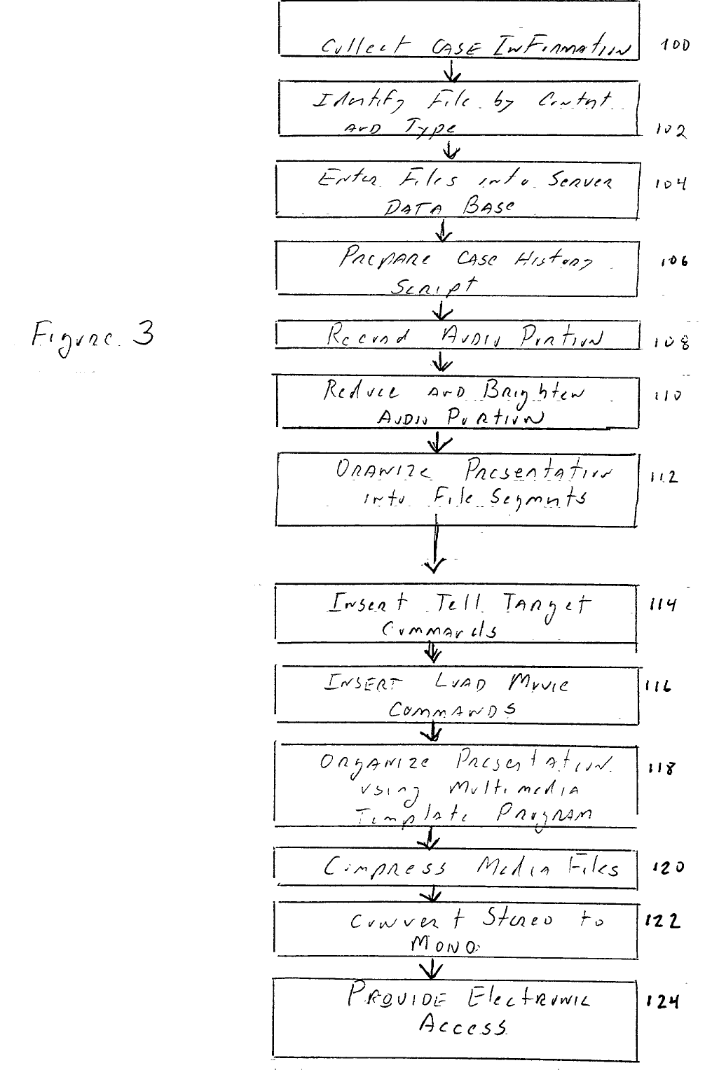

As illustrated in FIG. 3, in this embodiment, the medical case histories will be provided by selected medical experts using a standardized preparation format 100. In order to facilitate preparation of the program, the information will initially be organized into specific media component files 102 using a predetermined file naming convention and format that describes the substantive data component and file type of each electronic file. The labeling component files are then loaded onto an selected server database 104.

As previously discussed, a script of the case history presentation may then be prepared for each selected case history 106. The case history script identifies the specific text, graphic and video components to be used in the multimedia presentation . The case history script will also indicate how each specific media component is coordinated with a specific audio component. The case history script may then be transmitted to the originating professional in a secure electronic environment for his or her review and approval.

Once the case history script has been approved by the originating professional, the audio elements of the case history script may be recorded 108 and converted to a PC compatible WAVE format. The digital audio recording may then be converted to 16 bit format at a frequency of 11 kilohertz 110. This provides an acceptable level of high quality audio. The audio recording may then be stored on any suitable conventional electronic storage means.

As further illustrated in FIG. 3, the media component files containing selected case history material may then be electronically organized in accordance with the case history script 112. These related component media files are logically organized into discrete file presentations segments and logical break-up points may be identified 112. For purposes of this particular embodiment, the length of each presentation segment should not exceed about 1,000 frames and the initial presentation segment should not exceed 500 frames. This facilitates the seamless visual viewing of the presentation even by person using conventional dial up connections.

After the individual presentation segments are organized, the specific break points in each presentation segment may be identified by placing a tell-target command in each presentation segment 114. At a specified point in the presentation, this tell-target command 114 signals the programs and applications of the client computer to begin the process of playing a different segment of the presentation. One or more load-movie commands may also be inserted in each presentation segment 116. As described herein, the load movie commands may be used to selectively control downloading of the presentation segment elements. The load movie command instructs the user's operating system to look forward for the next segment at a particular point in a presentation segment. In this particular embodiment, each presentation segment that is about 1,000 frames long. The load movie command will siganal the operating system to begin the process of downloading the next presentation segment at frame 470 of the current presentation segment. Thus, the next succeeding presentation segment may be downloaded from the server to the browser of the client computer while the remaining 530 frames of the current 1,000 frame presentation segment are being viewed by the user. This facilities the simultaneous viewing and downloading of selected portions of the presentation.

The medical case history may be adapted for web based viewing using commercially available multimedia development tools program such as Macromedia's FLASH 118. In the instant embodiment, the visual elements of the multimedia presentation are preferably converted to a JPEG format and compressed by between 60 to 80 per cent 120. In order to facilitate compression, the graphics included in the presentation are preferably created using a line art illustration program which reduces the size of the files to be exported. The audio components are similarly converted to an MP3 format and are also compressed by approximately 80 percent. The audio may then be converted from stereo to mono at 24 kbps 122. The presentation may then be set up for electronic access viewing using HTML protocol and selected development tools 124.

The use of command scripts and compression techniques may be readily modified to provide quality multimedia programming of complex subject matter at various downloading speeds. The segment size and amount of compression may be readily adapted to achieve the specified level of program quality.

While preferred embodiments of the present invention have been described, it is to be understood that the embodiments described are illustrative only and the scope of the invention is to be defined solely to the appended claims when accorded a full range of equivalents, any modifications naturally occurring to those in the art from a perusal hereof.

We claim the following:

1. A method for preparing and presenting a web based multimedia presentation comprising:
(a) preparing a script of a multimedia presentation wherein said script identifies one or more component media files,
(b) naming and categorizing each said component media file based on its content;
(c) converting each said component media file to a selected digital format;
(d) recording an audio portion of said multimedia presentations;
(e) converting said audio portion to a WAVE format;
(f) reducing the quality of said audio portion;
(g) organizing each said media file into one or more presentation segments wherein each said presentation segment does not exceed about two minutes in length;
(h) placing a tell target command within each said presentation segment wherein said tell target command signals a browser to initiate a next presentation segment;
(i) inserting into each said presentation segment a load movie command wherein said load movie command instructs said browser to look forward for a specified presentation segment and to begin downloading said specified presentation segment before said presentation segment has been presented by said browser;
(j) establish multimedia template using multimedia programming tools;
(k) exporting files to said template and applying one or more compression techniques to reduce the size of each said presentation segment wherein:
each said presentation segment containing a video file is converted to a JPEG or GIF format and compressed at between about 40% to 60%, and
each said presentation segment containing an audio file is converted to an MP3 format and compressed by no more than about 60%;
(k) providing a secure electronic means for one or more selected users to access said presentation.

2. A method for accessing and viewing linked electronic files using a dial-up modem comprising:
(a) preparing a script of a multimedia presentation wherein said script:
identifies one or more media components of said multimedia presentation, wherein each said media component comprises a specified audio, video, text, or graphic file type; and
identified how each said media component coincides with a particular segment of an audio presentation,
(b) recording said audio presentation;
(c) converting said audio presentation to a WAVE format;
(d) converting each said media component into one or more presentation segments wherein each said presentation segment contains a predetermined number of frames;
(e) placing a first command within an initial presentation segment wherein said first command directs an operating system to display said initial presentation segment,
(f) placing a second command within each said presentation segment wherein said second command directs said operating system to begin downloading a specified presentation file while said presentation file is being viewed;
(g) placing a third command within each said presentation segment directing said operating system to:
(i) look forward for a specific presentation segment at a specified time within each said presentation segment, and
(ii) download said specific presentation segment to a user's browser,
(h) providing an electronic means for presenting, storing and retrieving said multimedia presentation;
(i) enabling said multimedia presentation using a Macrormedia Flash program; and
(j) providing a means for users to access the multimedia presentation using an electronic network.

3. The method of claim 2 wherein each said media component containing a video image ise converted to a JPEG format and compressed by about 50%.

4. The method of claim 3 wherein said media files containing audio are converted to a MP3 format and compressed to about 80%.

5. The method of claim 4 wherein said audio files are converted from stereo to 24 kbps mono.

6. The method of claim 5 wherein graphic material is converted to electronic form using a line art illustration program means.

7. The method of claim 6 wherein each said presentation segment contains about 1000 frames.

8. The method of claim 7 wherein said initial presentation segment contains about 500 frames.

9. A method for preparing and presenting multimedia presentations using large digital files comprising:
(a) naming and categorizing each media file by file type and content;
(b) preparing a script of a multimedia presentation wherein said script identifies each said media file to be used in said multimedia presentation;
(c) recording an audio portion of said multimedia presentation in a WAVE format;
(d) reducing said audio portion to 16 bit audio at about 11 kilo hertz;
(e) organizing said audio portion into one or more segments wherein each said segment does not exceed two minutes in length;
(f) developing said multimedia presentation using a multimedia programming means;
(g) placing tell target commands within each said segment to signal an operating system to initiate a next segment
(h) placing into each said segment a load movie command wherein said load movie command signals said browser to look forward for said next segment and to begin downloading said next segment while each said segment is being viewed;
(i) using a compression means to reduce the size of each said component; and
(j) providing a means for users to access and view said multimedia presentations.

10. A method for preparing and presenting multimedia medical information comprising the steps of:
(a) collecting medical case history information from a medical professional;
(b) organizing medical case history into one or more component files wherein each said component file is identified by content and file type;
(c) entering said component files into a sever database;
(d) preparing a program script for a multimedia presentation wherein said program script contain an audio portion and identifies one or more specific points where said component files are to be used in said multimedia presentation; and
(e) recording said audio portion based on said script,
(f) associating selected said component files with said specific points in said audio portion,
(g) determine one or more break points in said multimedia presentation,
(h) establish multimedia template layers using a selected multimedia programming template,
(i) place a load movie command at selected point in each said segment,
(j) placing a tell target command at selected points in each said segment, and
(k) compressing and exporting all files.

11. The method of claim 10 wherein said component files containing video images are converted to a JPEG format and compressed to about 50%.

12. The method of claim 11 wherein said component files containing audio are converted to a MP3 format and compressed to about 80%.

13. The method of claim 12 wherein said audio files are converted from stereo to 24 kbps mono.

14. The method of claim 13 wherein selected graphic material is converted to electronic form using a line art illustration program means.

15. The method of claim 14 wherein each said presentation segment contains about 1000 frames.

16. The method of claim 15 wherein said initial presentation segment contains about 500 frames.

17. The method of claim 10 wherein the selected multimedia programming template is a Macromedia FLASH program.
